(19) United States
(12) Patent Application Publication
(10) Pub. No.: US 2016/0189501 A1
(43) Pub. Date: Jun. 30, 2016

(54) SECURITY MONITORING SYSTEM AND CORRESPONDING ALARM TRIGGERING METHOD

(71) Applicant: BOLY MEDIA COMMUNICATIONS (SHENZHEN) CO., LTD., Shenzhen, Guangdong (CN)

(72) Inventors: Xiaoping HU, Shenzhen (CN); Xia SHEN, Shenzhen (CN)

(73) Assignee: BOLY MEDIA COMMUNICATIONS (SHENZHEN) CO., LTD., Shenzhen, Guangdong (CN)

(21) Appl. No.: 14/652,452

(22) PCT Filed: Aug. 5, 2013
(86) PCT No.: PCT/CN2013/080785

§ 371 Date: Jun. 15, 2015

(30) Foreign Application Priority Data
Dec. 17, 2012 (CN) 201210547337.5

(51) Int. Cl. G08B 13/196

(52) U.S. Cl. CPC G08B 13/19695; G08B 13/19602

(57) ABSTRACT

Provided are a security surveillance system and an alarm triggering method thereof. The method includes steps of: acquiring, by a first processor, a first signal indicating that an infrared sensor is triggered; controlling, according to the first signal, a first lens to capture a first image; acquiring a stored first background image; comparing the first image and the first background image to obtain a difference; and triggering a first alarm operation if the difference meets a preset condition. By using a manner in which infrared sensor detection and image difference detection function together, the probability of false alarm caused by high ambient temperature can be reduced.

### BACKGROUND

1. Technical Field

The present invention relates to the field of security surveillance technologies, and in particular, to a security surveillance system having an infrared detection function, and an alarm triggering method thereof.

2. Related Art

Currently existing graphics and image type security surveillance products mainly include two types:

One type is a video real-time surveillance products similar to a speed dome, this type of products mainly performs surveillance by using manual duty to find whether there is an intruder by viewing a video record in real time, and is mostly used in public places.

The other type is a camera sending an alarm by using a multimedia message. This type of products has the following major working principle: an infrared sensor, for example, a passive infrared (PIR) detector is used to sense whether there is an intruder, a picture is taken once the intruder is sensed, and image information is transmitted to a user through a communications network (for example, a wireless communications network). This type of products is easy to mount, and is suitable for family users.

For a security surveillance product, a false alarm will directly influence the application value of the product. Currently, for a method of reducing a false alarm rate of a video surveillance product, a Chinese patent No. CN100446043C and entitled “video security surveillance method based on bio-sensing and image information fusion” is provided, in which software for image recognition is added on the basis on infrared detection to reduce false alarms. This method is merely suitable for a video surveillance system, and is not suitable for a camera sending an alarm by using a multimedia message, this is because merely video can perform graphics processing through analysis on former and later frames. For the current camera sending an alarm by using a multimedia message, the alarm is triggered by using a single infrared detection technology, and therefore, it is easily interfered by an external environment to generate a false alarm. For example, when the ambient temperature in summer reaches or close to the human body temperature, and a surveillance area has a special environment such as an air vent, a large probability of a false alarm may be generated.

### SUMMARY

Embodiments of the present invention provides an alarm triggering method of a security surveillance system, including steps of: acquiring, by a first processor, a first signal indicating that an infrared sensor is triggered; controlling, according to the first signal, a first lens to capture a first image; acquiring a stored first background image; comparing the first image and the first background image to obtain a difference; and triggering a first alarm operation if the difference meets a preset condition.

The embodiments of the present invention further provides a security surveillance system, including: an infrared sensor, configured to detect infrared radiation in a surveillance area, and generate an infrared trigger signal when being triggered by the infrared radiation; a first lens, configured to capture an image in the surveillance area; a first storage, configured to store a first background image; a first processor, signal-connected to the infrared sensor, the first lens and the first storage, and configured to acquire the infrared trigger signal, and control, according to the infrared trigger signal, the first lens to capture a first image, acquire the stored first background image, compare the first image and the first background image to obtain a difference, and trigger a first alarm operation if the difference meets a preset condition.

The embodiments of the present invention further provides another security surveillance system, including: an infrared sensor, configured to detect infrared radiation in a surveillance area, and generate an infrared trigger signal when being triggered by the infrared radiation; a first lens, configured to capture an image in the surveillance area; a first storage, configured to store a first background image; a first processor, signal-connected to the first lens and the first storage; a second processor, signal-connected to the infrared sensor and the first processor, and configured to acquire an infrared trigger signal, send a first signal to the first processor according to the infrared trigger signal, and trigger a second alarm operation according to a second signal sent by the first processor; and a first processor, configured to acquire the first signal, control, according to the first signal, the first lens to capture a first image, acquire the stored first background image, compare the first image and the first background image to obtain a difference, and send the second signal to the second processor if the difference meets a preset condition.

The embodiments of the present invention uses a manner in which infrared sensor detection and image difference detection function together, on one hand, an image captured by a surveillance lens is compared with a pre-stored background image, image analysis may be used in a camera; on the other hand, on the basis of an infrared sensor being triggered, the image difference detection is added, the probability of false alarm caused by high ambient temperature can be reduced.

### BRIEF DESCRIPTION OF THE DRAWINGS

Embodiments of the present invention are described in detail through the following accompanying drawings.

FIG. 1 is a schematic flow chart of an alarm triggering method according to the present invention;

FIG. 2 is a schematic flow chart of another implementation manner of an alarm triggering method according to the present invention;

FIG. 3 is a schematic structural diagram of an implementation manner of a security surveillance system according to the present invention; and

FIG. 4 is a schematic structural diagram of another implementation manner of a security surveillance system according to the present invention.

### DETAILED DESCRIPTION

### Embodiment 1

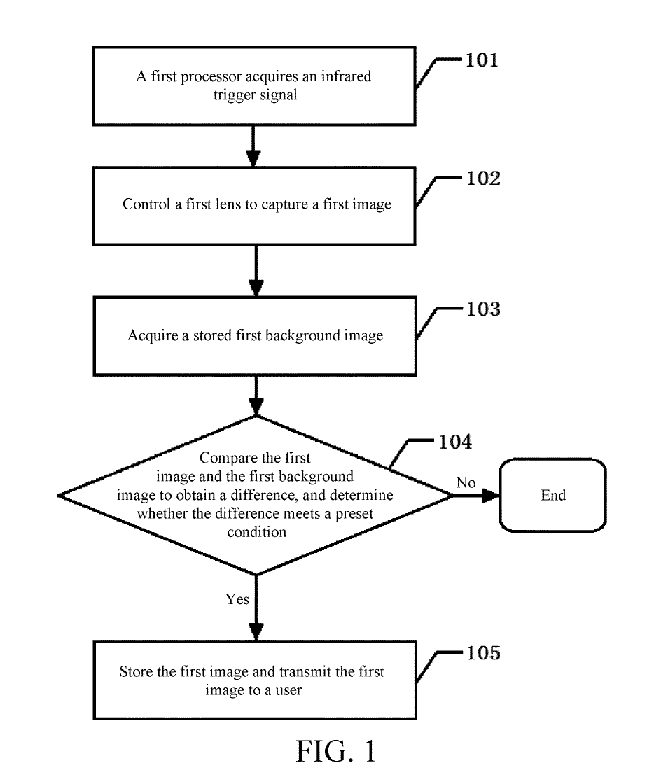

Referring to FIG. 1, an implementation manner of an alarm triggering method of a security surveillance system of the present invention includes the following steps:

101: A first processor acquires an infrared trigger signal generated when an infrared sensor signal-connected thereto is triggered.

The infrared sensor refers to a device capable of detecting infrared radiation in a surveillance area, for example, a PIR, which can generate an infrared trigger signal when being triggered by the infrared radiation.

It is understandable that, based on different sensor configurations, the generated infrared trigger signal may be a digital signal or an analog signal, which can be directly transmitted to a suitable interface of the first processor, and may be transmitted to a suitable interface of the first processor after being processed by normal software/hardware, such as analog/digital conversion, amplification, shaping, and filtering.

102: The first processor controls, according to the infrared trigger signal, a first lens to capture a first image.

The first lens may be a lens merely having a camera function, and a capturing area thereof may be greater than, smaller than, or partially overlapped to the surveillance area of the infrared sensor.

In this embodiment, the position of the first lens may be relatively fixed, and definitely, this does not limit an optical adjustment function thereof, for example, automatic focusing.

In other embodiments, the position of the first lens, for example, a horizontal direction of an optical axis, an elevation angle and the like may be adjusted, for example, the first lens may be fixed on a holder, and the first processor controls movement/rotation of the holder to adjust the position of the first lens.

103: The first processor acquires a stored first background image.

In this embodiment, the system pre-stores at least one background image and a corresponding capturing time. The background images are captured by the first lens (for example, captured in different times of a day, so as to acquire images of a background environment in different light conditions) under control of the first processor, and the first background image is the one selected from the stored background image and having the capturing time closest to a capturing time of the first image. It is understandable that, comparison on the capturing time generally can merely consider hour and more specific parts (for example, minute and second) while ignoring the date. For example, a first image captured at 12:00 in a certain day is compared with background images captured in a former day respectively at 12:00 and 15:00, it may be considered that the first image is closer to the time of the former. Definitely, in other embodiments, a factor of date may also be considered comprehensively, for example, a background image whose capturing date exceeds a set range is excluded from a selection range.

In other embodiments, the first processor may also acquire, from an external device such as an external storage device, at least one input background image and store the background image, for example, background images obtained by an engineer through analysis and arrangement on historical environment images. Definitely, the background images also each have a corresponding capturing time. In some embodiments, the first processor may provide a user interface to the user to display the stored background image, and/or perform a management operation on the stored background image according to an instruction input by the user, the management operation being one or more selected from the following: import, export, addition, deletion, and modification. For example, a background image is copied from the external storage according to an instruction input by the user through the user interface and is then stored, or a background image is acquired by the user through shooting by manual control.

In some embodiments, the first processor may further control the first lens to capture a background image according to a preset time interval to update the stored background image, thereby better ensuring effectiveness of a result of image comparison.

In some embodiments, a single first background image may be stored merely, for example, when a time interval in need of surveillance is short, or an algorithm capable of alleviating/removing an image difference caused by different light conditions is used.

104: The first processor compares the first image and the first background image to obtain a difference, and implements step 105 if the difference meets a preset condition.

In this embodiment, a specific manner and algorithm used for comparing the image different are not limited, and a condition of trigging an alarm operation is not limited either.

The former may be selected from various image processing, slicing and comparing technologies that are currently known or may occur in the future, and the latter may be set reasonably according to the requirement (for example, a false alarm rate and a missing report rate) of an actual surveillance by a person skilled in the art through limited times of experiments under the guide of the spirit of the present invention.

In this embodiment, the first processor compares the difference between the first image and the first background image by using analysis on the luminance and content, and set the preset condition as that the difference reaches a preset threshold. It is understandable that, if the preset threshold is low, a small image difference can trigger the alarm, the missing report rate will be reduced but the false alarm rate may be increased (but will not higher than the false alarm rate without setting image comparison), and if the preset threshold is high, a large image difference can trigger the alarm, the false alarm rate will be reduced but the missing report rate may be increased. Therefore, a threshold for triggering an alarm operation may be set reasonably according to an actual situation, for example, through experiments, such that a false alarm will not be generated due to entry of small animals such as cats and dogs, and a real intruder will not be missed.

For example, the first processor may specifically compare the first image and the first background image by using an image equalization luminance difference method or a color contrast method.

The image equalization luminance difference method includes first performing an equalization process of an average luminance on two images that need to be compared, that is, increase the luminance of the image having a lower luminance or reduce the luminance of the image having a higher luminance so that an average luminance thereof is the same as that of the other image, and a simple difference processing, an absolute value processing and a threshold processing are performed on the two images having the equalized luminance, a gravity and area of a non-zero image point of a luminance difference image (which can be considered as a “difference” after the image comparison) undergone the threshold processing may be considered as a center and an approximate area of a target object.

The color contrast method is similar to the image equalization luminance difference method, but each image used for comparison is not a luminance image thereof, but use respective two relative colorimetric images. First, for each image (the first image and the first background image) for comparison, two colorimetric components (for example, U and V components in a YUV image) thereof are detected, and are divided by an average luminance of the image to obtain two relative colorimetric images of the image. For each image for comparison, a difference processing and an absolute value processing are performed on the respective two relative colorimetric images. The two relative colorimetric images undergone the absolution value processing are then undergone a simple arithmetic summation (that is, u+v) or a vector summation (that is, (u*u+v*v)½). The image after the summation is then undergone a simple threshold processing, and a gravity and an area of a non-zero image point of an image after the threshold processing (which can be considered as a “difference” after the image comparison) may be considered as a center and an approximate area of the target object.

In other embodiments, after calculating a center and/or an area of the target object according to the difference between the first image and the first background image, the first processor further controls a parameter of the first lens according to a calculation result, the parameter being one or more selected from: a focal length, a direction, and an angle. For example, the first lens id controlled to perform automatic zooming, and/or a holder for placing the first lens is controlled to more/rotate, so as to adjust the first lens to position and track the target object. In some embodiments, the first processor further uses an edge or profile matching method (see “Perception of Shape and Motion”, Xiaoping Hu Ph.D. Thesis, University of Illinois at Urbana-Champaign, 1993) to perform precise matching on a boarder and profile of a target object to determine a position, motion speed and a motion direction thereof, thereby implementing more accurate positioning and tracking.

105: The first processor triggers a first alarm operation.

In this embodiment, the first alarm operation triggered by the first processor is storing the first image, and transmitting the first image to the user through a communication network. The used communication network may be a wireless or wired communication network, such as a mobile communication network, a public switched telephone network (PSTN), an integrated services digital network (ISDN), or an Ethernet.

In another embodiment, the first alarm operation may further include that the first processor controls the first lens to perform an automatic tracking and shooting on the target object, so as to acquire a long-term and clear image record of the target object.

In another embodiment, the first processor may merely store the first image, or merely transmits the first image to the user through the communication network without storing the first image, or trigger another type of sound and light alarm.

It is understandable that, if the first processor determines that the difference between the first image and the first background image does not meet the preset condition, no operation may be implemented, for example, the first image is not stored or transmitted.

By using the alarm triggering method of this embodiment, the processing on the trigger signal of the infrared sensor, the image comparison processing and the alarm operation are executed by the first processor, and may be implemented, for example, by adding an image comparison processing process in an existing alarm camera using infrared sensing. In this embodiment, by using double detection of infrared detection and image comparison, the false alarm rate of the surveillance system when the ambient temperature is close to the human body temperature may be reduced.

### Embodiment 2

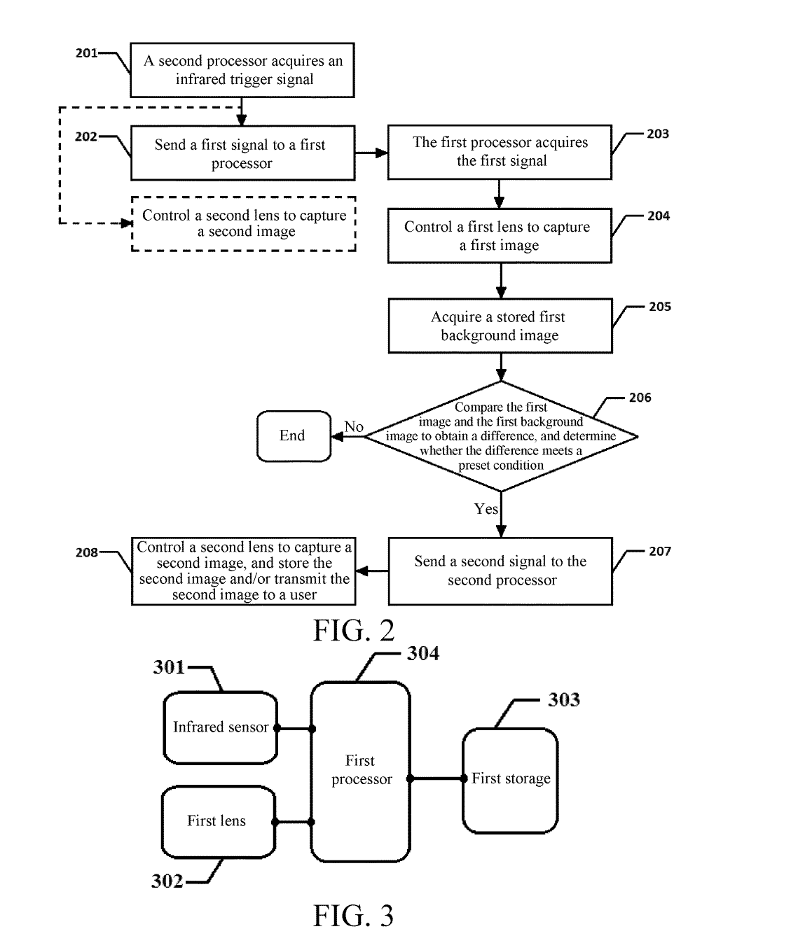

Referring to FIG. 2, another implementation manner of an alarm triggering method of a security surveillance system of the present invention is shown. Compared with Embodiment 1, a major difference of this embodiment lies in that a first processor mainly implements an operation of image difference comparison, and a second processor is responsible for processing a trigger signal of an infrared sensor and implementing a specific alarm operation. The method includes the following steps:

201: The second processor acquires an infrared trigger signal generated when an infrared sensor signal-connected thereto is triggered. The specific content of this step may refer to the description related to step 101 in Embodiment 1.

202: The second processor sends, according to the acquired infrared trigger signal, to the first processor a first signal indicating that an infrared sensor is triggered. The first signal may specifically use any form that can be understood by the first processor, such as, a single level change or a data signal.

203: The first processor acquires the first signal. It can be seen in combination with step 101 of Embodiment 1 that, the first signal acquired by the first processor may be the infrared trigger signal generated when the infrared sensor is triggered, and may also be, for example, the signal sent by the second processor and indicating that the infrared sensor is triggered.

204: The first processor controls, according to the first signal, a first lens to capture a first image.

205: The first processor acquires a stored first background image.

206: The first processor compares the first image and the first background image to obtain a difference, and implements step 207 if the difference meets a preset condition.

The specific content of steps 204 to 206 may refer to the descriptions related to steps 102 to 104 in Embodiment 1.

207: The first processor sends a second signal to the second processor, so as to instruct the second processor to trigger an alarm operation. It can be seen in combination with step 105 of Embodiment 1 that, the first alarm operation triggered by the first processor after the image comparison detection is passed may be a specific alarm operation, and may also be triggering another processor to implement a corresponding alarm operation.

208: The second processor controls, according to the second signal, a second lens to capture a second image, and triggers a second alarm operation.

In this embodiment, the second processor captures the second image after acquiring the second signal. In another embodiment, the second processor may also capture the second image (indicated by a dashed block in FIG. 2) immediately after acquiring the infrared trigger signal.

In this embodiment, the second alarm operation triggered by the second processor is storing the second image, and/or transmitting the second image to the user through a communication network. In another embodiment, when sending the second signal to the second processor, the first processor may further send the first image captured by the first lens to the second processor, and in this way, the alarm operation implemented by the second processor may correspondingly be storing the first image, and/or sending the first image to the user through the communication network. Moreover, the first processor may also perform automatic tracking and shooting on the target object, and transmit a corresponding image to the second processor, so that the second processor performs operations such as storing the image and/or transmitting the image to the user.

By using the alarm triggering method of this embodiment, the processing on the trigger signal of the infrared sensor and the image comparison processing are executed respectively by different processors, and may be implemented by configuring an independent system for image comparison processing (including the first processor and the first lens) for the existing alarm camera using infrared sensing. A main processor of the alarm camera using infrared sensing is equivalent to the second processor, a main lens thereof is equivalent to the second lens, a sub-processor newly added for performing background image comparison analysis is equivalent to the first processor, and a sub-lens used to capture a comparison image (the first image) is equivalent to the first lens. The image comparison processing process is executed by using an independent module, the original system resources are not occupied, so that the whole surveillance system can respond more timely and quickly. In addition, generally, the main lens has a configuration prior to the sub-lens, such as higher definition and better imaging effect, in an actual application, a solution of storing and transmitting the second image captured by the main lens is preferable, and the first image captured by the sub-lens is merely used for background comparison analysis.

### Embodiment 3

Referring to FIG. 3, an implementation manner of a security surveillance system of the present invention is shown. The security surveillance system of the present invention may be used to implement the alarm triggering method mentioned in Embodiment 1. The structure includes:

an infrared sensor 301, configured to detect infrared radiation in a surveillance area, and generate an infrared trigger signal when being triggered by the infrared radiation;

a first lens 302, configured to capture an image in the surveillance area;

a first storage 303, configured to store a first background image; and

a first processor 304, signal-connected to the infrared sensor 301, the first lens 302 and the first storage 303, and configured to run a program to implement a method comprising the following steps: acquiring the infrared trigger signal generated by the infrared sensor 301, controlling, according to the infrared trigger signal, the first lens 302 to capture a first image, acquiring the first background image stored by the first storage 303, comparing the first image and the first background image to obtain a difference, and triggering a first alarm operation if the difference meets a preset condition, for example, storing the first image, and/or transmitting the first image to a user through a communication network (not shown).

In this embodiment, the first image is stored in the first storage 303, and uses the same storage with the background image. In another embodiment, the first processor may also store the first image in another storage (not shown).

In some embodiments, a lens capable of sensing multiple spectrums may be used as the first lens. The multiple spectrums are one or any combination selected from the following: visible light, infrared light, and ultraviolet light. The multi-spectral lens can collect more abundant spectrum information than a common lens, for example, an infrared spectrum and an ultraviolet spectrum, so that it can provide a more precise reference of image comparison. Moreover, the multi-spectral lens can also work in broader environment conditions, for example, a multi-spectral lens capable of sensing infrared light can work in a dark environment or work at night normally.

### Embodiment 4

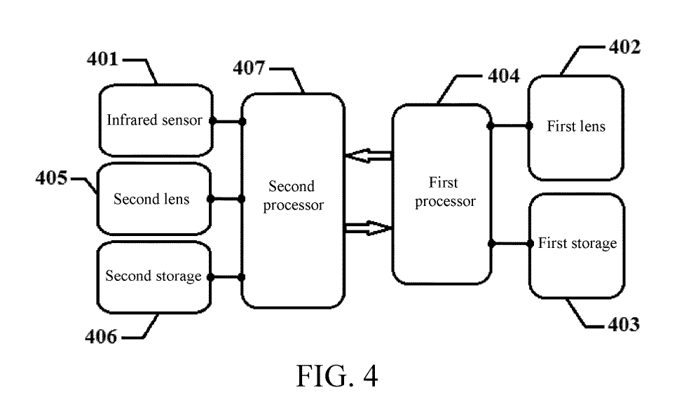

Referring to FIG. 4, another implementation manner of a security surveillance system of the present invention is shown. The security surveillance system of the present invention may be used to implement the alarm triggering method mentioned in Embodiment 2. The structure includes:

an infrared sensor 401, configured to detect infrared radiation in a surveillance area, and generate an infrared trigger signal when being triggered by the infrared radiation;

a first lens 402, configured to capture an image in the surveillance area;

a first storage 403, configured to store a first background image;

a first processor 404, signal-connected to the first lens 402 and the first storage 403;

a second lens 405, configured to capture an image in the surveillance area;

a second storage 406, configured to store an image captured by the second lens 405; and

a second processor 406, signal-connected to the infrared sensor 401, the first processor 404, the second lens 405 and the second storage 406, and configured to run a program to implement a method comprising the following steps: acquiring the infrared trigger signal generated by the infrared sensor 401, sending a first signal to the first processor 404 according to the acquired infrared trigger signal, controlling, according to the second signal sent by the first processor 404, the second lens 405 to capture a second image, and triggering a second alarm operation, for example, storing the second image in the second storage 406 and/or transmitting the second image to the ser through a communication network (not shown); and

the first processor 404, configured to run a program to implement a method comprising the following steps: acquiring the first signal, controlling, according to the first signal, the first lens 402 to capture a first image, acquiring the first background image stored by the first storage 403, comparing the first image and the first background image to obtain a difference, and sending the second signal to the second processor 405 if the difference meets a preset condition.

In this embodiment, after receiving the second signal sent by the first processor and indicating that the image comparison detection is passed, the second processor captures a second image again and stores the second image as an alarm image, and therefore, the system is provided with the second lens and the second storage.

In another embodiment, the second processor may also control the second lens to capture the second image immediately after acquiring the infrared trigger signal, but it is needed to trigger an operation of string and/or transmitting the second image after the second signal is acquired.

In another embodiment, if the first processor further uses the first image as an alarm image and transmits it to the second processor, the system does not need to be provided with the second lens, or even does not need to be provided with the second storage, for example, the first image may be stored in the first storage.

In some embodiments, a lens capable of sensing multiple spectrums may be used as the first lens and/or the second lens, so as to record more abundant and more accurate image information, or to adapt to broader surveillance environments.

By using the security surveillance system of this embodiment, independent parts (such as the first processor) are used to perform image comparison detection, the overall working speed of the alarm camera can be increased, thereby reducing time required by triggering the system and reducing the missing report rate.

The principle and implementation manners of the present invention are described in the foregoing through specific examples, and it should be understood that, the implementation manners are merely used to help understanding of the present invention, and are not intended to limit the present invention. A person of ordinary skill in the art may made variations on the specific implementation manners according to the spirit of the present invention.

1. An alarm triggering method for a security surveillance system, comprising:
acquiring, by a first processor, a first signal indicating that an infrared sensor is triggered;
controlling, according to the first signal, a first lens to capture a first image;
acquiring a stored first background image;
comparing the first image and the first background image to obtain a difference; and
trigger a first alarm operation if the difference meets a preset condition.

2. The method according to claim 1, wherein the first alarm operation triggered by the first processor comprises storing the first image, and/or transmitting the first image to a user through a communication network.

3. The method according to claim 1, wherein the first alarm operation triggered by the first processor comprises sending a second signal to a second processor, and the method further comprises:
acquiring, by the second processor, an infrared trigger signal generated when the infrared sensor is triggered, and sending, according to the infrared trigger signal, the first signal to the first processor; and
triggering, by the second processor, a second alarm operation according to the second signal.

4. The method according to claim 1, further comprising: controlling, by the second processor according to the infrared trigger signal or according to the second signal, a second lens to capture a second image; and
the second alarm operation triggered by the second processor comprises storing the second image, and/or transmitting the second image to a user through a communication network.

5. The method according to claim 1, further comprising:
controlling, by the first processor, the first lens to capture at least one background image or acquiring at least one input background image, and storing the at least one background image and a corresponding capturing time; the first background image being the one selected from the stored background image and having the capturing time the closest to a capturing time of the first image.

6. The method according to claim 5, further comprising:
controlling, by the first processor, the first lens to capture a background image according to a preset time interval so as to update the stored background image.

7. The method according to claim 1, wherein the comparing the first image and the first background image to obtain a difference comprises performing analysis comparison on luminance and content, and the preset condition comprises that the difference reaches a preset threshold.

8. The method according to claim 1, further comprising:
providing, by the first processor, a user interface to the user to display the stored background image, and/or performing a management operation on the stored background image according to an instruction input by the user, the management operation being one or more selected from the following: import, export, addition, deletion, and modification.

9. The method according to claim 1, further comprising:
calculating, by the first processor, a center and/or an area of a target object according to the difference between the first image and the first background image, and controlling a parameter of the first lens according to a calculation result, the parameter being one or more selected from: a focal length, a direction, and an angle.

10. A security surveillance system, comprising:
an infrared sensor, configured to detect infrared radiation in a surveillance area, and generate an infrared trigger signal when being triggered by the infrared radiation;
a first lens, configured to capture an image in the surveillance area;
a first storage, configured to store a first background image; and
a first processor, signal-connected to the infrared sensor, the first lens and the first storage, and configured to run a program to implement a method comprising the following steps:
acquiring the infrared trigger signal, controlling, according to the infrared trigger signal, the first lens to capture a first image, acquiring the stored first background image, comparing the first image and the first background image to obtain a difference, and triggering a first alarm operation if the difference meets a preset condition.

11. The system according to claim 10, wherein the first lens is a lens capable of sensing multiple spectrums, the multiple spectrums being one or any combination selected from the following: visible light, infrared light, and ultraviolet light.

12. A security surveillance system, comprising:
an infrared sensor, configured to detect infrared radiation in a surveillance area, and generate an infrared trigger signal when being triggered by the infrared radiation;
a first lens, configured to capture an image in the surveillance area;
a first storage, configured to store a first background image;
a first processor, signal-connected to the first lens and the first storage;
a second processor, signal-connected to the infrared sensor and the first processor, and configured to run a program to implement a method comprising the following steps: acquiring the infrared trigger signal, sending a first signal to the first processor according to the infrared trigger signal, and triggering a second alarm operation according to a second signal sent by the first processor; and
the first processor, configured to run a program to implement a method comprising the following steps: acquiring the first signal, controlling, according to the first signal, the first lens to capture a first image, acquiring the stored first background image, comparing the first image and the first background image to obtain a difference, and sending the second signal to the second processor if the difference meets a preset condition.

13. The system according to claim 12, further comprising:
a second lens, configured to capture an image in the surveillance area;
a second storage, configured to store an image captured by the second lens; and
the second processor being further signal-connected to the second lens and the second storage, the second processor being further configured to run a program to implement a method comprising the following steps: controlling, according to the infrared trigger signal or according to the second signal, the second lens to capture a second image; and
the second alarm operation comprising storing the second image, and/or transmitting the second image to a user through a communication network.

14. The system according to claim 13, wherein the first lens and/or second lens is a lens capable of sensing multiple spectrums, the multiple spectrums being one or any combination selected from the following: visible light, infrared light, and ultraviolet light.
